(19) United States
(12) Patent Application Publication
(10) Pub. No.: US 2017/0329744 A1
(43) Pub. Date: Nov. 16, 2017

(54) METHOD FOR PRODUCING MECHANICAL DEVICES COMPRISING SEVERAL ASSEMBLED IDENTICAL PARTS

(71) Applicant: Safran Aircraft Engines, PARIS (FR)

(72) Inventors: Olivier FERRY, Moissy-Cramayel (FR); Arnaud CAMBEFORT, MOISSY-CRAMAYEL (FR); Charles CLERET DE LANGAVANT, MOISSY-CRAMAYEL (FR)

(21) Appl. No.: 15/532,474

(22) PCT Filed: Dec. 4, 2015
(86) PCT No.: PCT/FR2015/053331

§ 371 Date: Jun. 1, 2017

(30) Foreign Application Priority Data
Dec. 5, 2014 (FR) 1462005

(51) Int. Cl. G06F 17/18; F01D 5/02; B23P 15/00

(52) U.S. Cl. CPC G06F 17/18; F05D 2230/80; F05D 2230/50; B23P 15/006; B23P 2700/01; F01D 5/02

(57) ABSTRACT

The invention relates to a method for producing a plurality of mechanical devices, in which each mechanical device comprises a defined number N of identical parts to be assembled, the parts to be assembled having been produced according to a set of specifications including at least one compliance specification, the parts that meet the compliance specification being compliant parts and the parts that do not meet the compliance specification being non-compliant parts, characterized in that production is controlled in such a way that the number of mechanical devices containing a number of non-compliant parts strictly higher than a threshold value n1 are in a proportion less than or equal to a proportion p1, the proportion p1 being non-zero and strictly lower than 1. The invention also relates to a method for repairing a mechanical device that has been produced with such a production method.

### FIELD OF THE INVENTION

The invention relates to a method of statistical monitoring of production criteria, for example in the aeronautics industry, in particular for easier production of mechanical devices comprising a set of several identical parts.

### PRIOR ART

Some mechanical devices comprise a set of several similar manufactured parts. This is the case, for example for manufacturing turbomachines which comprise a set of a certain number of machined parts.

Machining parts intended to be assembled to form the mechanical device follows a specific specification which includes especially particular manufacturing restrictions, and conformity specifications of the part, for example a particular dimensional specification.

Some parts produced are affected by deviations from the technical definition of the part, that is, they do not satisfy the conformity specification and are therefore considered non-compliant parts in terms of the definition. However, a part can be non-compliant in terms of the definition while being functionally acceptable.

To ensure that the mechanical device integrating different parts made in this way is compliant, one solution is to assemble only those parts made being compliant. But such a method is too strict since it would impose disposing of or rectifying all non-compliant parts, whether they respond to a functional need or not. This is very costly, whereas the mechanical device can have acceptable or even normal operation if it integrates a limited number of non-compliant parts.

So, designers of mechanical devices consider that said mechanical device is acceptable provided these parts in deviation are not present in more than a certain number per set or a sub-set of the machine (ex: engine, intermediate module, wheel, etc.).

For example, a deviation from the definition, noted E1, is deemed acceptable provided each mounted set has no more than n1 parts affected by the deviation E1, where n1 is for example equal to 2.

Such a requirement places a restriction on the producer who must verify precisely during assembly what are the non-conformities of parts, for example so as not to install on the same set more than n1 parts affected by the deviation E1, that is, more than two non-compliant parts in the case of the example above where n1 equals 2. This restriction is severe for the producer and substantially delays production volumes, since many verifications are necessary. This is particularly true when there are several deviations from the different definition accepted subject to being present in small numbers in a set. In fact it must be verified when assembling each set that there are no more than n1 parts affected by the first deviation from the definition E1, not more than n2 parts affected by the second deviation from the definition E2, not more than n3 parts affected by the third deviation from the definition E3 and so on.

This requirement also places a heavy restriction on the organisation responsible for maintenance of the machine, which is restricted in performing specific service monitoring (for example a fleet check), to ensure for example that when it comes to changing some worn parts of an set during revision, it is not a compliant part (without deviation from the definition) which is replaced by a non-compliant part (affected of the deviation E1) on an set which also already contained the maximum of n1 parts affected by the deviation E1. In practice, if this specific monitoring cannot be conducted, this obliges the organisation responsible for maintenance of machines to replace any defective part by a part showing no deviation from definition. So, any part intended for exchange must have no non-conformity, as this increases restrictions and therefore costs of manufacturing parts.

An aim of the present invention is to propose a method for production of mechanical assemblies integrating several identical parts, which resolves at least one of the above drawbacks.

In particular, an aim of the present invention is to propose a method for production of mechanical assemblies integrating several identical parts, which is simple to execute for the producer, without major restriction on verification of parts.

Yet another aim of the present invention is to propose a method for production of mechanical assemblies integrating several identical parts, which facilitates steps for later repairs and exchange of said set.

### SUMMARY OF THE INVENTION

For this reason, a method for production of a plurality of mechanical devices is proposed, where each mechanical device comprises a defined number N of identical parts to be assembled, the parts to be assembled having been produced according to a specification comprising at least one conformity specification, the parts satisfying the conformity specification being called compliant parts and the parts not satisfying the conformity specification being called non-compliant parts, characterised in that production is regulated so that the number of mechanical devices having a number of non-compliant parts strictly greater than a threshold n1 is in a proportion less than or equal to a proportion p1, the proportion p1 being non-zero and strictly less than 1.

Preferred though non-limiting aspects of this method, taken singly or in combination, are the following:
the parts intended to be assembled to form the mechanical devices are arranged in production batches comprising several parts, where each batch comprises a ratio of non-compliant parts relative to the compliant parts less than or equal to a dilution rate q1, the dilution rate q1 being non-zero and strictly less than 1.
the ratio of non-compliant parts relative to compliant parts in the production batches is equal to a dilution rate q1.
the dilution rate q₁ is selected so as to satisfy the relationship [R]:

$$1 - {\sum }_{k = 0}^{{n}_{1}} ( \begin{matrix}N \\ k\end{matrix} ) {{q}_{1}^{k} ( 1 - {q}_{1} )}^{N - k} \leq {p}_{1} \qquad [ R ]$$

the maximal dilution rate q₁ is selected to satisfy the relationship [R].
each production batch is formed from at least N parts and comprises at least one non-compliant part.

A method for repairing a mechanical device is also proposed, having been produced with such a method for production, for the purpose of replacing one of the parts assembled in said mechanical device, in which said part to be replaced is replaced by another identical part selected randomly in a production batch.

### DESCRIPTION OF FIGURES

Other characteristics and advantages of the invention will emerge from the following description which is purely illustrative and non-limiting and must be viewed with respect to the attached diagrams, in which:

FIG. 1 is a graphic illustrating a first embodiment of the invention;

FIG. 2 is a graphic illustrating a second embodiment of the invention.

### DETAILED DESCRIPTION OF THE INVENTION

In the following description a mechanical device is a set comprising inter alia a set of a plurality of identical parts relative to each other.

Identical parts means parts made according to the same specification and which are therefore supposed to be identical, or similar at the very least.

The identical parts to be assembled have been made according to the same specification comprising at least one conformity specification, that is, a particular definition, in dimensional terms for example.

The parts satisfying the conformity specification are qualified as compliant parts, that is, they are parts having no deviation from the definition.

Those parts not satisfying the conformity specification are qualified as non-compliant parts, that is, they are parts having at least one deviation from the definition, for example a deviation E1 from a first definition.

The production requirement described earlier for manufacturing mechanical devices comprising a set of several identical parts according to which no mechanical device having more than n1 non-compliant parts is accepted (that is, parts affected by a production deviation E1) results in excessive logistical restrictions which encouraged the inventors to install a new production method of this type of devices.

It is proposed to impose a less production requirement, and introduce a probabilistic notion in regulating production to ensure that production undertaken respects overall use restrictions.

More precisely, production is now being regulated with a restriction where the number of mechanical devices having a number of non-compliant parts strictly greater than a threshold n1 is in a proportion less than or equal to a proportion p1, the proportion p1 being non-zero and strictly less than 1.

Production is therefore regulated to retain the probability that the mechanical devices have a number of non-compliant parts strictly greater than a threshold n1 in a proportion less than or equal to a proportion p1, the proportion p1 being non-zero and strictly less than 1.

In other words, during production of such assemblies, from now on it is required that a proportion of mechanical devices less than a given proportion p1 contains more than n1 parts affected by the deviation E1.

The proportion p1 is fixed and selected as a function of the functional need and the acceptability of associated risks. For example, the proportion p1 can be a proportion selected greater than or equal to 1 device in 10,000, greater than or equal to 1 device in 5000, greater than or equal to 1 device in 1000, or even greater than or equal to 1 device in 100.

According to this new requirement, it is possible to deliver parts to the assembly workshop where production of assembled devices is carried out simply by controlling the proportion of parts affected by different deviations contained in the batches of parts to ensure that the relaxed requirement presented hereinabove will be verified.

Assuming that the parts to be mounted on each mechanical device, and those to be changed during revisions or repairs to said device, are selected randomly, it is possible to deliver parts affected by the deviation in question, subject to ensuring the new requirement.

For this, it is suitable to control the dilution rate of parts affected by the deviation E₁ at the time of delivery, that is, prior to production installation or during repairs.

The dilution rate noted q1 corresponds in reality to the frequency with which parts affected by the deviation E1, that is, non-compliant parts, are delivered.

The probability that there are more of these non-compliant parts are on the same set than n1 is determined by calculation.

In particular, when the dilution rate of the deviation E1 is q1 (for example q1 equal to 1/100 means that a part affected by the deviation E1 was delivered for every 100 parts delivered), and the number of parts on the set (engine) is N, the probability of having exactly X1 equal to k parts affected by the deviation E1 on the set is:

$$ℙ ( {X}_{1} = k ) = ( \begin{matrix}N \\ k\end{matrix} ) {{q}_{1}^{k} ( 1 - {q}_{1} )}^{N - k}$$

With the dilution rate q1 for the deviation E1, the probability of having more than n1 parts affected by the deviation E1 among the N parts mounted on the set is therefore:

$$ℙ ( {X}_{1} > {n}_{1} ) = 1 - {\sum }_{k = 0}^{{n}_{1}} ( \begin{matrix}N \\ k\end{matrix} ) {{q}_{1}^{k} ( 1 - {q}_{1} )}^{N - k}$$

For a given production, it is suitable therefore to calculate the dilution rate q1 such that [symbol] (X₁>n₁)≦p₁.

The dilution rate q1 is therefore selected so as to satisfy the relationship [R]:

$$1 - {\sum }_{k = 0}^{{n}_{1}} ( \begin{matrix}N \\ k\end{matrix} ) {{q}_{1}^{k} ( 1 - {q}_{1} )}^{N - k} \leq {p}_{1} \qquad [ R ]$$

The biggest value possible of the dilution rate q1 which satisfies the relationship [R] hereinabove is preferably selected.

According to the proposed method for production, are arranged the parts intended to be assembled to form the mechanical devices in production batches comprising several parts, where each batch comprises a ratio of non-compliant parts relative to the compliant parts less than or equal to a dilution rate q1, the dilution rate q1 being non-zero and strictly less than 1.

The largest ratio possible will preferably be taken, which uses the largest number of non-compliant parts having been produced.

The maximal value of dilution rate q1 is therefore imposed preferably at the time of creation of batches intended to be delivered for production. For example, if q1=1/50 is the maximal acceptable value, it suffices to deliver a part affected by the deviation E1 every 50 parts delivered to ensure that the requirement will be verified.

To improve the method for production of mechanical devices having several identical parts assembled, there is therefore a reliance on tools for statistical control of processes. More precisely, a controlled risk of seeing an unwanted event occur is being guaranteed.

However, in terms of statistical control of processes, this unwanted event is, in all specific cases, extremely simple and concerns production of a non-compliant part.

The unwanted event here is the simultaneous assembly of a certain number of parts affected by deviations from the definition on the same set. The choice of this type of highly specific event results from problems specific to production of mechanical devices integrating parts of very high added value, and are difficult to manufacture, many of them mounted on a machine in which their effects will be combined.

The method for production proposed hereinabove exceeds the capacities of traditional tools of statistical control of processes to the extent where the techniques used in these existing tools are aimed at simply ensuring a very low risk of producing non-conformities, whereas the proposed process offers, via adequate control of a dilution rate, a guarantee of the risk of assembling within the same entity (wheel, machine, etc.) deviations from the definition already produced.

According to a first embodiment of the proposed method, production of turbine wheels is considered, where each wheel comprises a set of N=60 identical blades. A wheel is considered acceptable if it contains a maximum n1=10 non-compliant blades.

According to this first example, the aim is to have a maximum p1=200 ppm (200/1,000,000) of chances of having more than n1 non-compliant blades per mounted wheel.

By way of calculation, it is evident that the probability of having 11 non-compliant blades or more per wheel produced as a function of the dilution rate q1 in the production batch is such that:
for batches (L1-1) of 60 blades produced comprising 5 non-compliant blades (or q1=5/60), the probability is 1.00%, which is greater than the threshold of 200 ppm. The associated dilution rate is therefore not suitable for the required production;
for batches (L1-2) of 60 blades produced comprising 4 non-compliant blades (or q1=4/60), the probability is 0.19%, which is greater than the threshold of 200 ppm. The associated dilution rate is therefore not suitable for the required production;
for batches (L1-3) of 60 blades produced comprising 3 non-compliant blades (or q1=3/60), the probability is 171 ppm, which is less than the threshold of 200 ppm. The associated dilution rate is therefore suitable for the required production of wheels and can be used to package batches of blades intended for production of wheels according to the first example.

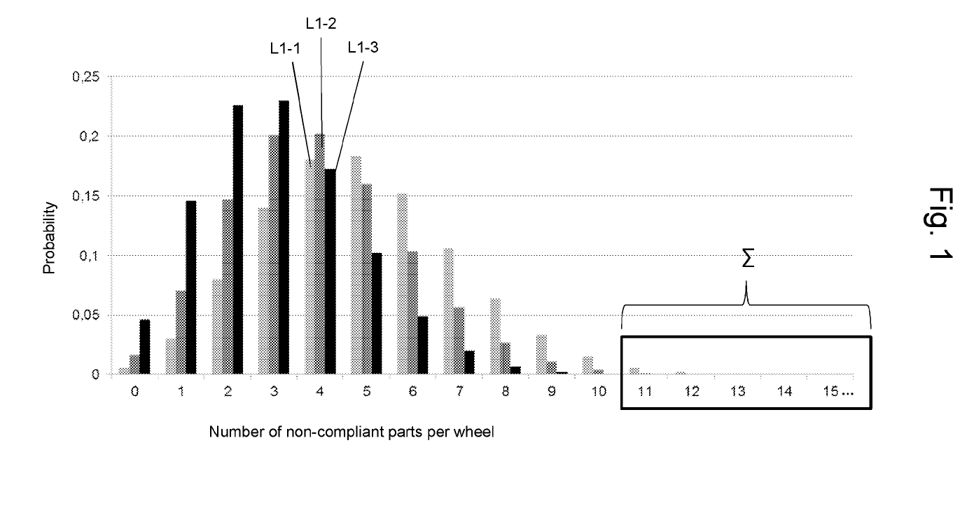

FIG. 1 is a graphic illustrating this example and represents the probability of presenting exactly n non-compliant blades per wheel for various delivery injection rates (batches L1-1, L1-2 and L1-3 hereinabove). For each injection rate, a check is made as to whether the sum Σ of the probabilities where n>10 is less than or equal to the threshold of 200 ppm.

According to a second embodiment of the proposed method, the production of turbine wheels is also considered, where this time each wheel comprises a set of N=17 identical blades. A wheel is considered as acceptable if it contains a maximum of n1=4 non-compliant blades.

According to this second example, the aim is to have a maximum p1=200 ppm (200/1,000,000) chances of having more than n1 non-compliant blades per mounted wheel.

By way of calculation, it is evident that the probability of having 5 non-compliant blades or more per wheel produced as a function of the dilution rate q1 in the production batch is such that:
for batches (L2-1) of 17 blades produced comprising 2 non-compliant blades (or q1=2/17), the probability is 4.14%, which is greater than the threshold of 200 ppm. The associated dilution rate is therefore not suitable for the required production;
for batches (L2-2) of 17 blades comprising 1 blade non-compliant (or q1=1/17), the probability is 0.24%, which is greater than the threshold of 200 ppm. The associated dilution rate is therefore not suitable for the required production;
for batches (L2-3) of 34 blades (or 2 batches of 17 blades) comprising 1 blade non-compliant (or q1=1/34), the probability is 101 ppm, which is less than the threshold of 200 ppm. The associated dilution rate is therefore suitable for the required production of wheels and can be used for packaging the batches of blades intended for production of wheels according to the second example.

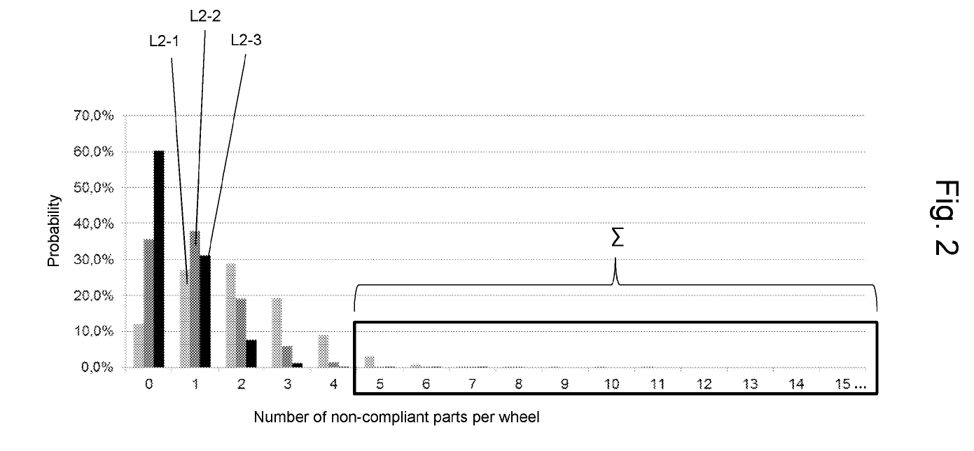

FIG. 2 is a graphic illustrating this example and represents the probability of presenting exactly n non-compliant blades per wheel for various delivery injection rates (batches L2-1, L2-2 and L2-3 hereinabove). For each injection rate, a check is made as to whether the sum Σ of the probabilities where n>4 is less than or equal to the threshold of 200 ppm.

1. A method for production of a plurality of mechanical devices, where each mechanical device comprises a defined number N of identical parts to be assembled, the parts to be assembled having been produced according to a specification comprising at least one conformity specification, the parts satisfying the conformity specification being compliant parts and the parts not satisfying the conformity specification being non-compliant parts,
wherein the production is regulated so that the number of mechanical devices having a number of non-compliant parts strictly greater than a threshold n1 is in a proportion less than or equal to a proportion p1, the proportion p1 being non-zero and strictly less than 1, the parts intended to be assembled to form the mechanical devices are arranged in production batches comprising several parts, where each batch comprises a ratio of non-compliant parts relative to the compliant parts less than or equal to a dilution rate q1, the dilution rate q1 being non-zero and strictly less than 1 and being the maximal rate selected to satisfy the relationship [R]:
$$1 - {\sum }_{k = 0}^{{n}_{1}} ( \begin{matrix}N \\ k\end{matrix} ) {{q}_{1}^{k} ( 1 - {q}_{1} )}^{N - k} \leq {p}_{1} \qquad [ R ]$$

2. The method as claimed in claim 1, in which the ratio of non-compliant parts relative to the compliant parts in the production batches is equal to a dilution rate q1.

3. The method as claimed in claim 1, in which each production batch is formed from at least N parts and comprises at least one non-compliant part.

4. A method for repairing a mechanical device having been produced with a method for production of a plurality of mechanical devices, where each mechanical device comprises a defined number N of identical parts to be assembled, the parts to be assembled having been produced according to a specification comprising at least one conformity specification, the parts satisfying the conformity specification being compliant parts and the parts not satisfying the conformity specification being non-compliant parts, wherein the production is regulated so that the number of mechanical devices having a number of non-compliant parts strictly greater than a threshold n1 is in a proportion less than or equal to a proportion p1, the proportion p1 being non-zero and strictly less than 1, the parts intended to be assembled to form the mechanical devices are arranged in production batches comprising several parts, where each batch comprises a ratio of non-compliant parts relative to the compliant parts less than or equal to a dilution rate q1, the dilution rate q1 being non-zero and strictly less than 1 and being the maximal rate selected to satisfy the relationship [R]:
$$1 - {\sum }_{k = 0}^{{n}_{1}} ( \begin{matrix}N \\ k\end{matrix} ) {{q}_{1}^{k} ( 1 - {q}_{1} )}^{N - k} \leq {p}_{1} \qquad [ R ]$$
wherein for the purpose of replacing one of the parts assembled in said mechanical device, said part to be replaced is replaced by another identical part selected randomly in a production batch.

5. The method as claimed in claim 4, in which the ratio of non-compliant parts relative to the compliant parts in the production batches is equal to a dilution rate q1.

6. The method as claimed in claim 4, in which each production batch is formed from at least N parts and comprises at least one non-compliant part.

7. The method as claimed in claim 5, in which each production batch is formed from at least N parts and comprises at least one non-compliant part.

8. The method as claimed in claim 2, in which each production batch is formed from at least N parts and comprises at least one non-compliant part.
